(19) United States
(12) Patent Application Publication
(10) Pub. No.: US 2014/0217116 A1
(43) Pub. Date: Aug. 7, 2014

(54) LIQUID DISPENSER

(71) Applicant: GP Strategies Corporation, Columbia, MD (US)

(72) Inventor: Michael Mackey, San Diego, CA (US)

(73) Assignee: GP Strategies Corporation, Columbia, MD (US)

(21) Appl. No.: 14/250,071

(22) Filed: Apr. 10, 2014

Related U.S. Application Data
(63) Continuation of application No. 13/305,102, filed on Nov. 28, 2011.
(60) Provisional application No. 61/418,679, filed on Dec. 1, 2010.

(51) Int. Cl. F17C 13/02; F17C 7/02

(52) U.S. Cl. CPC F17C 13/026; F17C 7/02
USPC 222/1; 222/52

(57) ABSTRACT

Embodiments of the disclosure may include a dispensing system for dispensing a cryogenic fluid. The dispensing system may include a cryogenic fluid dispenser, a pump, and a conduit connecting the pump to the dispenser. The system may also include a processor and a vehicle detection subsystem configured to detect a vehicle. When the vehicle detection subsystem provides to the processor a signal reflecting detection of a vehicle, the processor may initiate a pre-chill operation that prepares at least one of the pump or the dispenser to dispense the cryogenic fluid.

### CROSS REFERENCE TO RELATED APPLICATIONS

This patent application is a continuation-in-part of U.S. patent application Ser. No. 13/305,102, filed Nov. 28, 2011, which claims the benefit of priority under 35 U.S.C. §§119 and 120 to U.S. Provisional Patent Application No. 61/418,679, filed Dec. 1, 2010, both of which are incorporated herein by reference in their entirety.

### FIELD OF THE DISCLOSURE

Embodiments of the present disclosure include dispensers, and more particularly, dispensers for pre-chilling, dispensing, and metering a liquid, such as liquefied natural gas.

### BACKGROUND OF THE DISCLOSURE

Generally speaking, liquefied natural gas (LNG) presents a viable fuel alternative to, for example, gasoline and diesel fuel. More specifically, LNG may be utilized as an alternative fuel to power certain vehicles. However, a primary concern in commercializing LNG includes accurately measuring the amount of LNG that is dispensed for use. Particularly, the National Institute of Standards and Technology of the United States Department of Commerce has developed guidelines for federal Weights and Measures certification, whereby dispensed LNG must be metered on a mass flow basis with a certain degree of accuracy. Such a mass flow may be calculated by measuring a volumetric flow rate of the LNG and applying a density factor of the LNG to that volumetric flow rate.

Typically, LNG dispensers may be employed to dispense LNG for commercial use. Such LNG dispensers may use mass flow measuring devices, such as a Corilois-type flow meter, or may include devices to determine the density of the LNG and the volumetric flow of the LNG. For example, the density may be determined by measuring the dielectric constant and the temperature of the LNG flowing through the dispenser. As the LNG flows through a dispensing chamber of the dispenser, a capacitance probe may measure the dielectric constant, and a temperature probe may measure the temperature. The measured dielectric constant and temperature may then be utilized to calculate the density of LNG flowing through the dispenser by known principles. A volumetric flow rate of the LNG may then be determined by, for example, a volumetric flow meter associated with the dispensing chamber. The acquired density and volumetric flow rate may be used to compute the mass flow rate of the dispensed LNG.

The existing configuration of LNG dispensers may have certain limitations. For example, LNG dispensers utilizing a Coriolis-type flow meter must be cooled to a suitable LNG temperature prior to dispensing, which requires metered flow of LNG to be diverted back to an LNG source. In addition, Coriolis-type flow meters are generally expensive. Furthermore, typical LNG dispensers house both the density-measuring device and the volumetric flow-measuring device within the same chamber, which results in an undesirably bulky LNG dispenser. Additionally, preparing an LNG dispenser for dispensing fuel may take time and may cause undesirable delay for consumers. Alternatively, maintaining a dispenser in a constant state of readiness for dispensing LNG may consume undue amounts of power and may generate unwanted byproducts, such as heat. It may also place undue stress on the dispensing system components, which could increase maintenance costs as a result of more frequent repairs and/or more frequent replacement of parts. The dispenser of the present disclosure is directed to improvements in the existing technology.

### SUMMARY OF THE DISCLOSURE

In accordance with an embodiment, a dispensing system for dispensing a cryogenic fluid may include a cryogenic fluid dispenser, a pump, and a conduit connecting the pump to the dispenser. The dispensing system may also include a processor and a vehicle detection subsystem configured to detect a vehicle. When the vehicle detection subsystem provides to the processor a signal reflecting detection of a vehicle, the processor may initiate a pre-chill operation that prepares at least one of the pump or the dispenser to dispense the cryogenic fluid.

Various embodiments of the disclosure may include one or more of the following aspects: the cryogenic fluid dispenser may include a measurement chamber configured to receive the cryogenic fluid, the measurement chamber including at least one probe for measuring a property of the cryogenic fluid, a first conduit including an inlet in fluid communication with the measurement chamber, a flow meter coupled to the first conduit, and a second conduit configured to return the cryogenic fluid to a source, wherein the inlet, the second conduit, and the flow meter are vertically stacked relative to each other along the first conduit; the vehicle detection subsystem may include at least one of an induction loop, an infrared sensor, a pressure sensor, a radio-frequency identification sensor, an ultrasonic sensor, or a radar sensor; the vehicle detection subsystem may include a sensor configured to detect a vehicle in the vicinity of the cryogenic fluid dispenser; the system may include a plurality of dispensers and a plurality of sensors, wherein each of the plurality of sensors is configured to detect a vehicle in the vicinity of one of the plurality of dispensers; the at least one probe may include a temperature probe; the second conduit may be configured to directly deliver the cryogenic fluid to the flow meter; and the cryogenic fluid may be liquefied natural gas.

In accordance with another embodiment, a dispensing system for dispensing a liquid may include a pump and a liquid dispenser having a measurement chamber configured to receive the liquid, the measurement chamber including at least one probe for measuring a property of the liquid, a first conduit configured to deliver the liquid out of the dispenser, a flow meter coupled to the first conduit, and a second conduit configured to return the liquid to a source, wherein the second conduit is positioned upstream of the flow meter. The dispensing system may also include a vehicle detection subsystem and a processor operably coupled to the vehicle detection subsystem, the pump, and the liquid dispenser.

Various embodiments of the disclosure may include one or more of the following aspects: the vehicle detection subsystem may include at least one of an induction loop, an infrared sensor, a pressure sensor, a radio-frequency identification sensor, an ultrasonic sensor, or a radar sensor; the vehicle detection subsystem may include a sensor configured to detect a vehicle in the vicinity of the liquid dispenser; the system may include a plurality of dispensers and a plurality of sensors, wherein each of the plurality of sensors is configured to detect a vehicle in the vicinity of one of the plurality of dispensers; and the at least one probe may include a temperature probe and a capacitance probe.

In accordance with yet another embodiment of the disclosure, a method for dispensing a liquid from a dispenser may include anticipating a demand for the liquid, initiating a pre-chill process to cool at least one of the dispenser or a pump associated with the dispenser to at least a predetermined temperature, receiving a demand for the liquid, and dispensing the liquid once at least one of the dispenser or the pump is cooled to the predetermined temperature.

Various embodiments of the disclosure may include one or more of the following aspects: at least one of the dispenser or the pump may be cooled to the predetermined temperature before the demand is received; anticipating the demand for the liquid may include detecting a vehicle using a vehicle detection subsystem; the system may include resetting the vehicle detection subsystem once the vehicle is no longer present; the liquid may be natural gas; the pre-chill process may include pumping the liquid from a liquid source, through the pump, through the dispenser, and returning the liquid to the liquid source; and the pump may be located within a chamber and the pre-chill process may include flowing fluid into the chamber.

In accordance with yet another embodiment of the disclosure, a method for dispensing a liquid from a dispenser may include detecting the presence of a vehicle and initiating a pre-chill process to cool at least one of the dispenser or a pump associated with the dispenser to at least a predetermined temperature upon detection of the vehicle.

Various embodiments of the disclosure may include one or more of the following aspects; the liquid may be natural gas; the pre-chill process may be initiated for a predetermined amount of time; the method may further include stopping the pre-chill process if no demand for the liquid is received within the predetermined amount of time; a vehicle detection subsystem may be used to detect the presence of the vehicle, and the method may comprise resetting the vehicle detection subsystem once the vehicle is no longer present; the method may further comprise receiving a demand for the liquid and dispensing the liquid; the predetermined temperature may be reached before the demand for the liquid is received; and the pre-chill process may include pumping the liquid from a liquid source, through the pump, through the dispenser, and returning the liquid to the liquid source.

In this respect, before explaining at least one embodiment of the present disclosure in detail, it is to be understood that the present disclosure is not limited in its application to the details of construction and to the arrangements of the components set forth in the following description or illustrated in the drawings. The present disclosure is capable of embodiments in addition to those described and of being practiced and carried out in various ways. Also, it is to be understood that the phraseology and terminology employed herein, as well as the abstract, are for the purpose of description and should not be regarded as limiting.

The accompanying drawings illustrate certain exemplary embodiments of the present disclosure, and together with the description, serve to explain the principles of the present disclosure.

As such, those skilled in the art will appreciate that the conception upon which this disclosure is based may readily be used as a basis for designing other structures, methods, and systems for carrying out the several purposes of the present disclosure. It is important, therefore, to recognize that the claims should be regarded as including such equivalent constructions insofar as they do not depart from the spirit and scope of the present disclosure.

### BRIEF DESCRIPTION OF THE DRAWINGS

FIG. 1 illustrates a diagrammatic representation of an LNG dispensing system, according to an exemplary disclosed embodiment;

FIG. 2 illustrates a schematic depiction of an LNG dispenser, according to an exemplary disclosed embodiment;

FIG. 3 illustrates a schematic depiction of another LNG dispenser, according to an exemplary disclosed embodiment;

FIG. 4 illustrates a schematic depiction of another LNG dispenser, according to an exemplary disclosed embodiment;

FIG. 5 illustrates a block diagram for an exemplary process of dispensing LNG by the LNG dispensing system of FIG. 1, according to an exemplary disclosed embodiment;

FIG. 6 illustrates a diagrammatic representation of an LNG dispensing system, according to an exemplary disclosed embodiment;

FIG. 7 illustrates a schematic depiction of a vehicle detection system, according to an exemplary disclosed embodiment; and

FIG. 8 illustrates a block diagram for an exemplary process of dispensing LNG by the LNG dispensing system of FIG. 6, according to an exemplary disclosed embodiment.

### DETAILED DESCRIPTION

Reference will now be made in detail to the exemplary embodiments of the present disclosure described above and illustrated in the accompanying drawings.

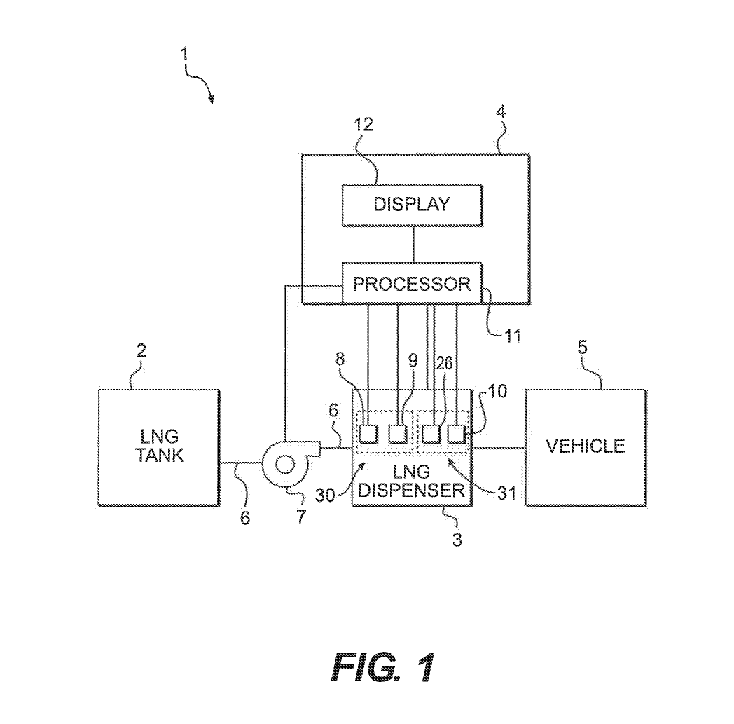

FIG. 1 illustrates a diagrammatic representation of an LNG dispensing system 1, according to an exemplary embodiment. LNG dispensing system 1 may include an LNG tank 2, an LNG dispenser 3, and a control system 4. LNG dispensing system 1 may be configured to deliver a cryogenic liquid to a use device, such as vehicles, ships, and the like. In the exemplary embodiment of FIG. 1, LNG dispensing system 1 may deliver LNG to a vehicle 5. While the present disclosure will refer to LNG as the liquid to be employed, it should be appreciated that any other liquid may be utilized by the present disclosure. Furthermore, in addition to vehicle 5, any other use device may receive the liquid from LNG dispensing system 1.

LNG tank 2 may include an insulated bulk storage tank for storing a large volume of LNG. An insulated communication line 6 may fluidly couple LNG tank 2 to LNG dispenser 3. A pump 7 may be located within a pump chamber and may be incorporated into communication line 6 to deliver LNG from LNG tank 2 to LNG dispenser 3 via communication line 6. Pump 7 may be partially or completely surrounded by liquid in the pump chamber.

LNG dispenser 3 may be configured to dispense LNG to, for example, vehicle 5. LNG dispenser 3 may include a density-measuring device 30 and a flow-measuring device 31. Density-measuring device 30 may be located adjacent or proximate to flow-measuring device 31. In certain embodiments, however, density-measuring device 30 may be operably coupled yet separated from flow-measuring device 31 at a desired distance. Moreover, it should be appreciated that a single density-measuring device 30 may be operably coupled to a plurality of flow-measuring devices 31. Density-measuring device 30 may include a capacitance probe 8 and a temperature probe 9. Capacitance probe 8 may measure a dielectric constant of the LNG flowing through LNG dispenser 3, while temperature probe 9 may measure the temperature of the flowing LNG. Flow-measuring device 31 may include a volumetric flow meter 10 and a secondary temperature probe 26. Volumetric flow meter 10 may measure a volumetric flow rate of the LNG flowing through LNG dispenser 3, and secondary temperature probe 26 may also measure the temperature of LNG.

Control system 4 may include a processor 11 and a display 12. Processor 11 may be in communication with pump 7 and LNG dispenser 3. In addition, control system 4 may also be in communication with one or more computers and/or controllers associated with a fuel station. Processor 11 may also be in communication with density-measuring device 30, including capacitance probe 8 and temperature probe 9, and flow-measuring device 31, including secondary temperature probe 26 and volumetric flow meter 10. As such, processor 11 may receive dielectric constant data, temperature data, and volumetric flow rate data to compute and determine other properties of the LNG, such as density and mass flow rate. Processor 11 may also signal pump 7 to initiate and cease delivery of LNG from LNG tank 2 to LNG dispenser 3, and may control the dispensing of LNG out from LNG dispenser 3. Moreover, processor 11 may include a timer or similar means to determine or set a duration of time for which LNG may be dispensed from LNG dispenser 3. Display 12 may include any type of device (e.g., CRT monitors, LCD screens, etc.) capable of graphically depicting information. For example, display 12 may depict information related to properties of the dispensed LNG including dielectric constant, temperature, density, volumetric flow rate, mass flow rate, the unit price of dispensed LNG, and related costs.

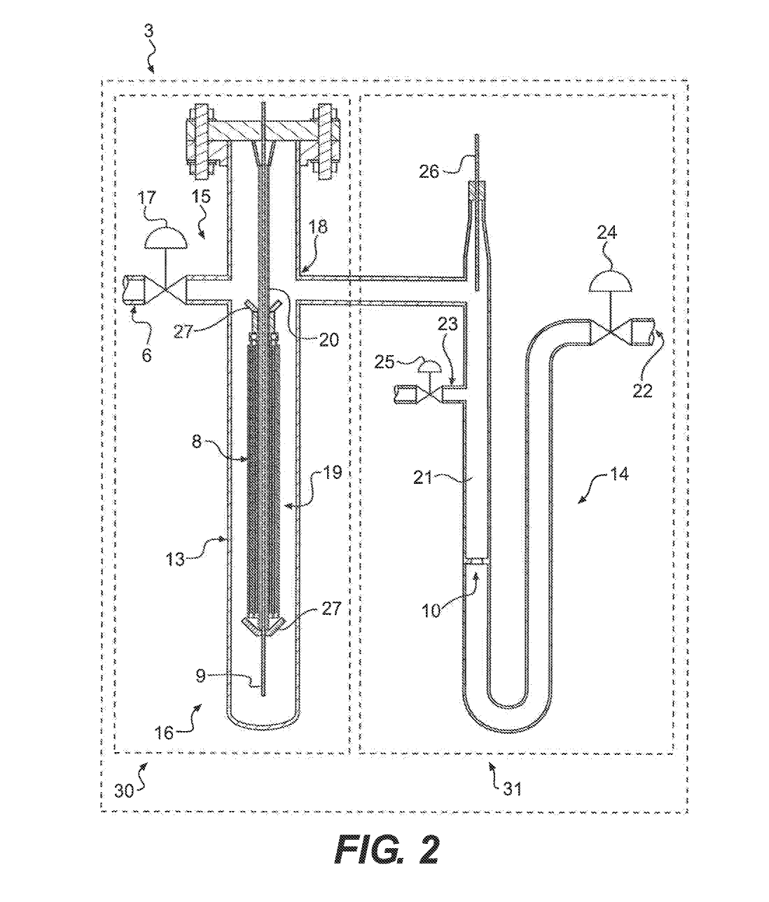

FIG. 2 illustrates a schematic depiction of LNG dispenser 3, according to an exemplary disclosed embodiment. As shown in FIG. 2, density-measuring device 30 may include a density measurement chamber 13, an inlet conduit fluidly coupled to communication line 6, and an outlet conduit 18. Density measurement chamber 13 may include, for example, a columnar housing containing temperature probe 9, capacitance probe 8, and one or more deflector plates 27. Deflector plate 27 may be any suitable structure configured to deflect or divert LNG vapor and/or bubbles from contacting capacitance probe 8 and causing capacitance measurement inaccuracies. For example, deflector plate 27 may be a thin sheet of material coupled to capacitance probe 8 at an angle to deflect away LNG vapor and/or bubbles.

Communication line 6 may feed LNG into measurement chamber 13. FIG. 2 illustrates that communication line 6 may be positioned in an upper portion 15 of density measurement chamber 13 to provide a still-well design for density measurements. An inlet control valve 17 may be coupled to communication line 6 and may be in communication with processor 11. Accordingly, inlet control valve 17 may selectively open and close to control LNG flow into density measurement chamber 13 in response to signals from processor 11. Outlet conduit 18 may fluidly couple density-measurement device 30 to flow-measuring device 31. Particularly, outlet conduit 18 may be positioned at or near upper portion 15 such that LNG may sufficiently fill density measurement chamber 13. In other words, the still-well design of density measurement chamber 13 may collect a static volume of LNG, with capacitance and temperature probes 8, 9 immersed in the LNG. The static volume may minimize turbulence and prolong contact between LNG and capacitance probe 8 and temperature probe 9, and deflector plates 27 may minimize or eliminate LNG vapor from entering capacitance probe 8, which may ultimately improve the accuracy of dielectric constant and temperature measurements.

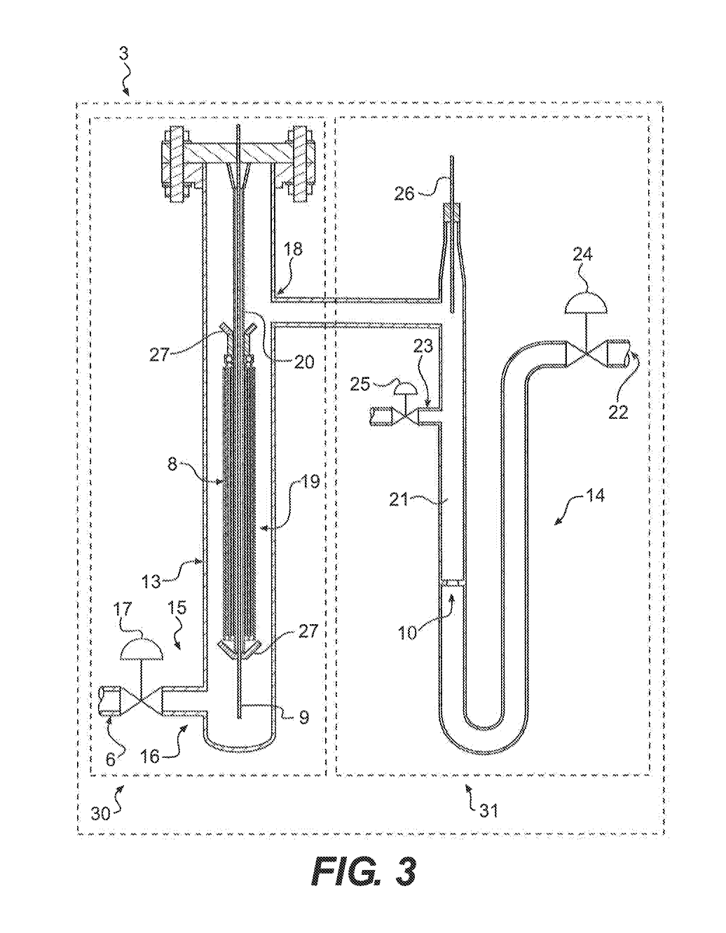

Although FIG. 2 illustrates that communication line 6 may be positioned in upper portion 15 of density measurement chamber 13, it should also be appreciated that communication line 6 may be alternatively positioned anywhere along the length of density measurement chamber 13. For example, and as illustrated in FIG. 3, communication line 6 may be positioned in a bottom portion 16 of density measurement chamber 13. Such a configuration may provide a flow-through type design, wherein a flowing volume of LNG may contact capacitance and temperature probes 8, 9 for temperature and dielectric constant measurements.

Capacitance probe 8 may include two or more concentric electrode tubes or rings 19. As is known in the art, the dielectric of the LNG between the walls of concentric electrode rings 19 may be obtained and signaled to processor 11. The measured dielectric of the LNG may then be quantified as the dielectric constant. Temperature probe 9 may be housed by capacitance probe 8. That is, temperature probe 9 may be positioned within capacitance probe 8, and particularly, may be disposed within an innermost electrode ring 20. Such a configuration may reduce the diameter of density measurement chamber 13, and therefore the overall footprint and cost of LNG dispenser 3. Furthermore, innermost electrode ring 20 may be an electrically grounded electrode. Therefore, interference or undesired influence to the dielectric or temperature readings due to incidental contact between temperature probe 9 and innermost electrode ring 20 may be prevented. Furthermore, in certain embodiments, temperature probe 9 and capacitance probe 8 may share a common central axis.

Row-measuring device 31 may include a flow meter chamber 21, volumetric flow meter 10, an outlet chamber 14, an outlet control valve 24, an outlet conduit 22, a chill-down conduit 23, and a chill-down valve 25. Flow-measuring device 31 may receive LNG from density measurement chamber 13. In certain embodiments, flow-measuring device 31 may directly receive LNG from pump 7 if density measurements are not required.

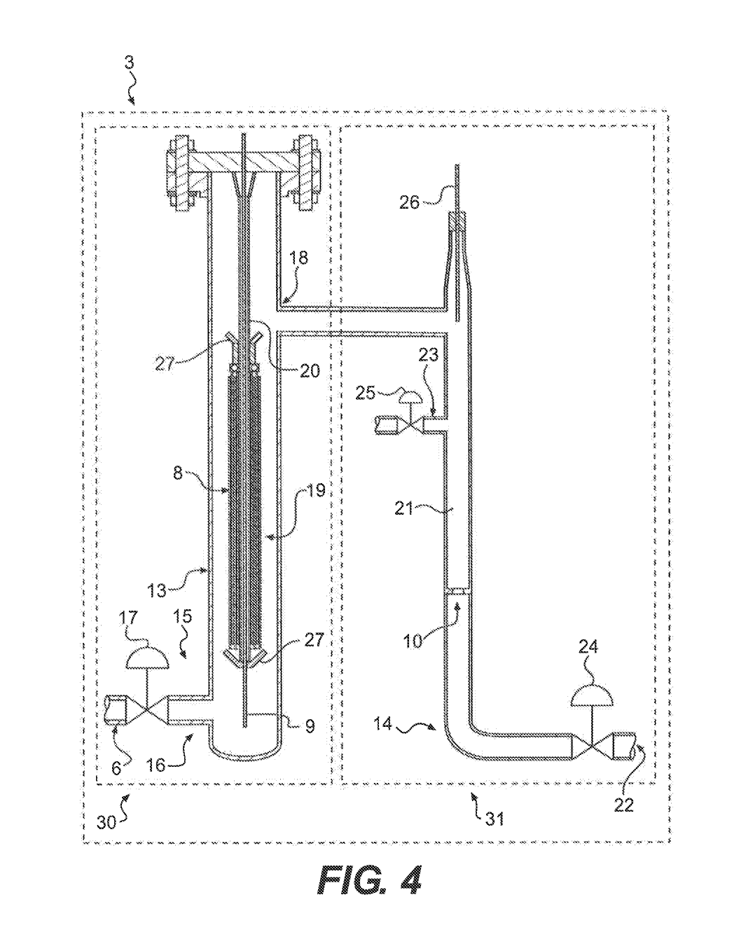

Flow meter chamber 21 and outlet chamber 14 may be configured in a U-shape. It should be appreciated, however, that flow meter chamber 21 and outlet chamber 14 may be configured in any other shape or configuration that facilitates LNG to fill volumetric flow meter 10, fill flow meter chamber 21, and flow through chill-down conduit 23 when chill-down valve 25 is open and outlet control valve 24 is closed, for example, as is shown in the embodiment of FIG. 4. Moreover, LNG may fill volumetric flow meter 10 prior to opening outlet control valve 24 to improve the accuracy of the LNG flow measurements.

Chill-down conduit 23 may be positioned upstream of volumetric flow meter 10 and outlet control valve 24 such that LNG flow through chill-down conduit 23 may not impact the measurement of LNG flow though outlet conduit 22. Chill-down conduit 23 may fluidly couple flow meter chamber 21 with LNG tank 2 and may be configured to return LNG from outlet conduit 14 to LNG tank 2. Chill-down valve 25 may be in communication with processor 11 and may be configured to selectively open and close in response to signals from processor 11. In certain embodiments, a two-way pump (not shown) may be coupled to chill-down conduit 23 to deliver and extract LNG to and from flow meter chamber 21.

Chill-down conduit 23 may return LNG back to LNG tank 2 after flow-measuring device 31 has been initially cooled. In such an initial cooling mode, LNG may be pumped from communication line 6 and into density measurement chamber 13 and flow meter chamber 21 prior to LNG measurements being taken by capacitance and temperature probes 8, 9, and prior to LNG being dispensed from outlet conduit 22. That is, flow-measuring device 31 may be filled with LNG prior to opening outlet control valve 24. The initial cooling mode therefore may calibrate the LNG dispenser 3 such that density-measuring device 30 and flow meter chamber 21 may be cooled down to a temperature substantially consistent of that of LNG within LNG tank 2. This calibration period may improve the accuracy of the dielectric constant and temperature measurements taken by capacitance and temperature probes 8, 9. In addition, the calibration period may cool the structure of LNG dispenser 3. That is, during the calibration period, LNG may be pumped through LNG dispenser 3 to cool the walls defining LNG dispenser 3 to further improve the accuracy of dielectric constant and temperature readings.

Because chill-down conduit 23 may be positioned upstream of volumetric flow meter 10, chill-down conduit 23 may directly feed LNG through the volumetric flow meter 10 to calibrate meter 10. For example, in some instances, LNG vapor may be present in flow meter chamber 21 and may flow through volumetric flow meter 10. Since the presence of LNG vapor in meter 10 may result in erroneous or inaccurate LNG volumetric flow rate measurements, it may be beneficial to flush out the LNG vapor prior to measuring the volumetric flow rate of LNG to be dispensed from LNG dispenser 3. Chill-down conduit 23 may directly feed LNG from LNG tank 2 to flush out any undesirable LNG vapors, thereby improving the accuracy of volumetric flow meter 10 and further cooling the outlet conduit 14. The flushing of LNG vapors from meter 10 may also be carried out during the initial cooling mode.

Volumetric flow meter 10 may include any device known in the art configured to measure the volumetric flow rate of a fluid. For example, volumetric flow meter 10 may include an orifice plate, a flow nozzle, or a Venturi nozzle. Data related to the volumetric flow rate of LNG passing through volumetric flow meter 10 may be communicated to processor 11.

Outlet control valve 24 may be coupled to outlet chamber 14 and may be in communication with processor 11. Accordingly, outlet control valve 24 may selectively open and close to control LNG dispensed from outlet chamber 14 in response to signals from processor 11.

In one or more embodiments, secondary temperature probe 26 may be positioned within flow meter chamber 21. Secondary temperature probe 26 may be in communication with processor 11 and configured to measure the temperature of LNG flowing through flow meter chamber 21. LNG temperature between density-measuring device 30 and flow meter chamber 21 may therefore be tracked by processor 11, and any substantial deviations in LNG temperature may be identified.

Outlet chamber 14 may exhibit a vertical configuration. In other words, secondary temperature probe 26, inlet 18, LNG calibration line 23, and volumetric flow meter 10 may be vertically stacked relative to each other along flow meter chamber 21. Such a configuration may reduce the size and overall footprint of flow-measuring device 31.

Although only one flow-measuring device 31 fluidly coupled to density-measuring device 30 is illustrated, it should be appreciated that LNG dispenser 3 may include more than one flow-measuring device 31. Multiple flow-measuring devices 31 may advantageously measure and deliver LNG to multiple destinations (e.g., multiple use vehicles), while utilizing a single density-measuring device 30 to measure and track LNG density via LNG temperature and dielectric constant. The single density-measuring device 30 may reduce the overall space and equipment necessary for LNG dispenser 3.

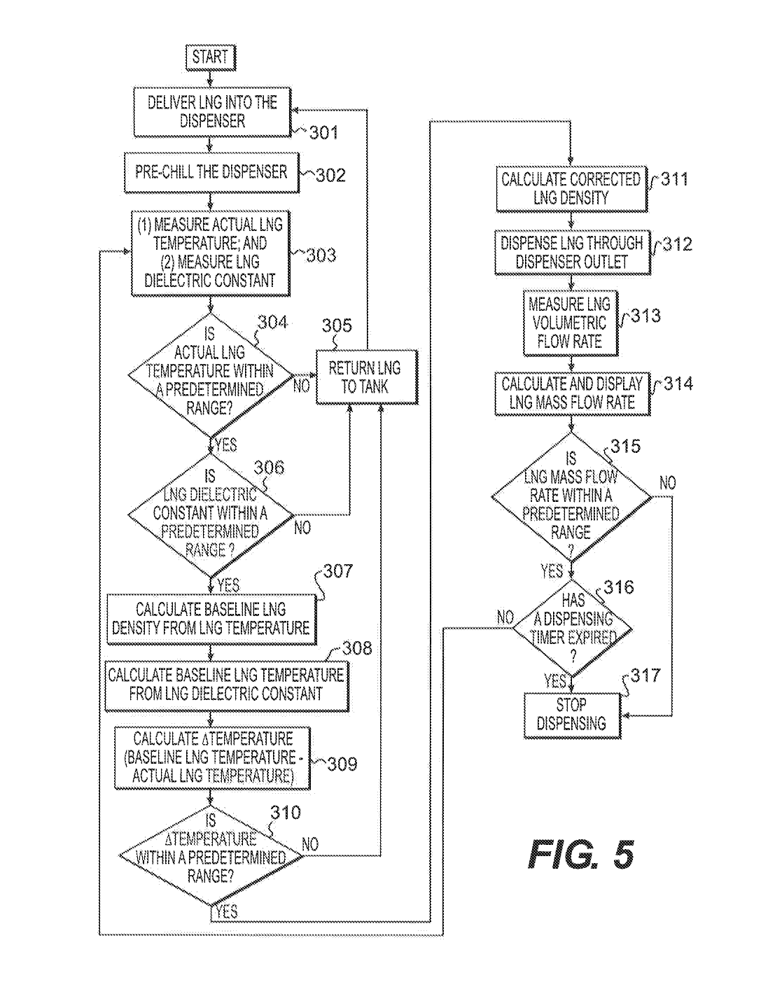

FIG. 5 is a block diagram illustrating a process of dispensing LNG by LNG dispensing system 1, according to an exemplary disclosed embodiment. LNG may first be delivered into LNG dispenser 3 from LNG tank 2, step 301. However, prior to dispensing LNG out of LNG dispenser 3, LNG dispenser 3 may be “pre-chilled,” step 302. In other words, LNG dispenser 3 may undergo the above-described initial cooling mode, where LNG is pumped from LNG tank 2, through LNG dispenser, and back to LNG tank 2 via chill-down conduit 23. Outlet control valve 24 may be in a closed positioned at this stage. LNG dispenser 3 therefore may be sufficiently cooled to approximately the temperature of the LNG from LNG tank 2. Furthermore, the “pre-chill” stage may include the step of flushing out any LNG vapor that may be present within flow meter chamber 21. That is, LNG from tank 2 may be directly pumped through flow-measuring device 31 via LNG calibration line 23 to expel any LNG vapors that may create inaccurate readings by meter 10 by filling meter 10 with LNG. Additionally, or alternatively, LNG delivered from density-measuring device 30 may be pumped through flow-metering device to flush out any LNG vapors.

It should be appreciated that prior to the “pre-chill” stage, capacitance probe 8 and temperature probe 9 may be calibrated for measuring LNG by any process known in the art.

During the “pre-chill” stage, temperature probe 9 (and in some embodiments secondary temperature probe 26) may track the temperature of LNG flowing through LNG dispenser 3. The temperature readings may be sent to processor 11 and displayed on display 12. Once the temperature has stabilized, LNG dispenser 3 may have reached a sufficient cooling temperature, and chill-down control valve 25 may be closed. Properties of the to-be-dispensed LNG may then be measured from a static volume of LNG or a flowing volume of LNG within density-measuring device 30, step 303.

Temperature probe 9 may measure the actual LNG temperature within density-measuring device 30, and capacitance probe 8 may measure the LNG dielectric constant of the LNG within density-measuring device 30. Actual LNG temperature and LNG dielectric constant may be transmitted to processor 11 for evaluation and computational purposes. For example, processor 11 may compare the actual LNG temperature to a predetermined range of temperatures stored in a memory unit of processor 11, step 304. Processor 11 may determine that the actual LNG temperature is at an appropriate dispensing temperature if the actual LNG temperature is within a predetermined range of acceptable LNG dispensing temperatures (e.g., between −260° F. and −170° F.). In one embodiment, the predetermined range of acceptable LNG dispensing temperatures may be based on set standards for Weights and Measures certification. If processor 11 determines that the actual LNG temperature is not within a predetermined range of acceptable LNG dispensing temperatures, processor 11 may actuate chill-down control valve 25 (and in certain embodiments the pump associated with chill-down conduit 23) to deliver LNG within LNG dispenser 3 back to LNG tank 2, step 305. LNG from tank 2 may then be delivered to LNG dispenser 3, step 301.

If actual LNG temperature is within the predetermined range of acceptable LNG temperatures, processor 11 may then compare the measured LNG dielectric constant to a predetermined range of dielectric constants stored in the memory unit of processor 11, step 306. For instance, processor 11 may determine that the LNG dielectric constant is indicative of LNG appropriate for dispensing if the LNG dielectric constant is within a predetermined range of acceptable LNG dielectric constants (e.g., between 1.48 and 1.69). In one embodiment, the predetermined range of acceptable LNG dielectric constants may be based on set standards for Weights and Measures certification. If processor 11 determines that the LNG dielectric constant is not within a predetermined range of acceptable LNG dielectric constants, LNG within LNG dispenser 3 may be returned back to LNG tank 2, step 305, or dispensing may be disabled.

However, if the LNG dielectric constant is within the predetermined range, processor 11 may calculate a baseline LNG density based on the measured LNG temperature from secondary temperature probe 26, step 307. Processor 11 may utilize programmed look-up tables, appropriate databases, and/or known principles and algorithms to determine the baseline LNG density based on the measured LNG temperature from secondary temperature probe 26.

Because the composition of LNG may vary as it is pumped through LNG dispenser 3, LNG density calculations may need to be determined throughout the dispensing operation. The calculated LNG density will be determined by incorporating algorithms based on the relationship between LNG dielectric constant and LNG temperature, as described below.

Processor 11 may determine a baseline LNG temperature based on the measured LNG dielectric constant, step 308. The baseline LNG temperature may be a temperature correlating to the measured LNG dielectric constant. That is, the baseline LNG temperature may be what the temperature of the LNG should be assuming the LNG has the measured dielectric constant and a baseline composition (e.g., 97% methane, 2% ethane, and 1% nitrogen or any other baseline composition). To determine the baseline LNG temperature, processor 11 may utilize pre-programmed data and/or known principles and algorithms.

Processor 11 then may calculate the difference between the baseline LNG temperature and the actual LNG temperature, step 309, and determine whether the temperature difference is within a predetermined range (e.g., between −25° F. and 25° F.), step 310. In one embodiment, the predetermined range of temperature differentials may be based on set standards for Weights and Measures certification. If the temperature difference is not within the predetermined temperature range, the LNG within the LNG dispenser 3 may be returned to LNG tank 2, step 305, or dispensing may be disabled.

If the temperature difference is within the predetermined range, processor 11 may then calculate a corrected LNG density, step 311. The corrected LNG density may compensate for variations in LNG composition. Particularly, processor 11 may calculate a density correction factor based on the difference between the actual and baseline LNG temperatures. Density correction factor may be calculated by inputting the temperature difference into known principles, algorithms, and/or equations programmed into processor 11.

The density correction factor may then be applied to the baseline LNG density to determine the corrected LNG density. Particularly, processor 11 may multiply the baseline LNG density with the density correction factor to calculate the corrected LNG density.

Once the corrected LNG density is obtained, processor 11 may actuate outlet control valve 24 to dispense the LNG out of outlet conduit 22, step 312. As the LNG is dispensed from LNG dispenser 3, processor 11 may obtain a volumetric flow rate of LNG measured by volumetric flow meter 10, step 313. As is known in the art, processor 11 may apply the corrected LNG density to the volumetric flow rate to arrive at a mass flow rate of the dispensed LNG, step 314. Moreover, processor 11 may continually update and display the mass flow rate of the dispensed LNG.

Processor 11 may further determine whether the mass flow rate of the dispensed LNG is within a predetermined range of acceptable mass flow rates, step 315. The predetermined range of acceptable mass flow rates may be bound by a minimum acceptable mass flow rate and a maximum acceptable mass flow rate. If the measured mass flow rate of the dispensed LNG is between the minimum and maximum acceptable mass flow rates, LNG dispensing system 1 may continue to dispense LNG through LNG dispenser 3, and may continue to measure and update the mass flow rate of the dispensed LNG. However, if the mass flow rate of the dispensed LNG is outside the predetermined range (e.g., less than the acceptable minimum mass flow rate or greater than the acceptable maximum mass flow rate), processor 11 may then determine whether the LNG has been dispensed for an appropriate duration of time, which may be preset by processor 11. For example, processor 11 may determine if a dispensing timer set by processor 11 has expired, step 316. If the dispensing timer has expired, LNG dispensing system 1 may terminate LNG dispensing, step 317.

With an accurate measurement of LNG mass flow rate, LNG dispensing system 1 may dispense a desired or a predetermined mass of LNG to, for example, vehicle 5. Particularly, processor 11 may determine the mass of LNG dispensed by monitoring an amount of time LNG is dispensed at the measured LNG mass flow rate. Once processor 11 has determined that the mass of the dispensed LNG has reached the desired mass, processor 11 may terminate LNG dispensing.

In some embodiments, the dispenser is able to anticipate the need to dispense LNG and initiate the pre-chill stage. For example, LNG dispensing system 1 may track consumer demand over time and may begin pre-chilling LNG dispenser 3 based on the time of day, e.g., in anticipation of an increase in demand. In other embodiments, processor 11 may initiate the pre-chill stage at certain, predetermined times of day, without tracking patterns of consumer demand. In the embodiments described below, a vehicle detection subsystem is used to detect a vehicle in proximity to the LNG dispenser. In such embodiments, for example, processor 11 initiates the pre-chill stage in response to the presence of an approaching LNG consumer or the detection of an awaiting vehicle 5.

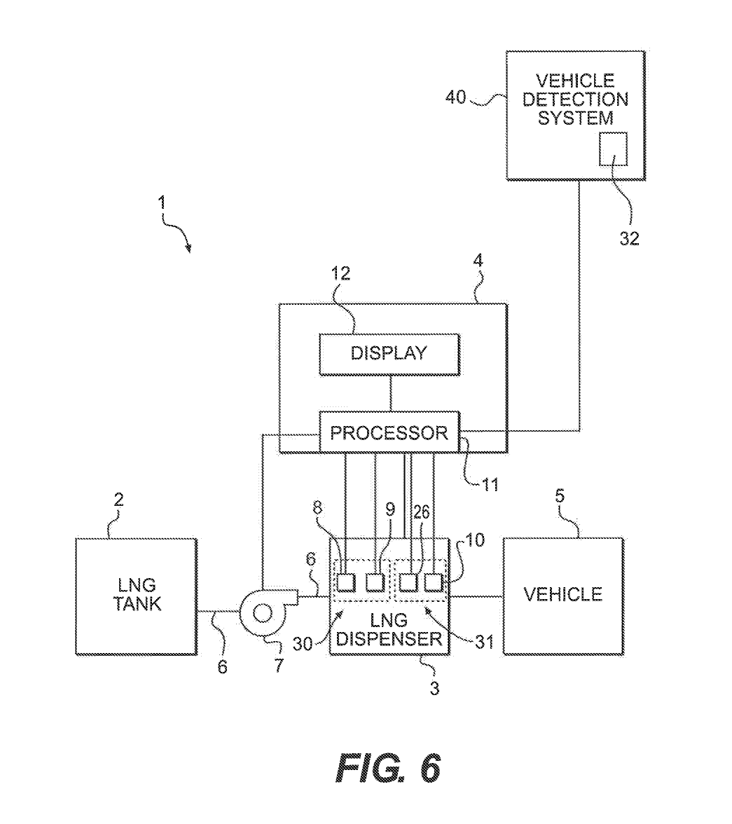

In the embodiment of FIG. 6, the pre-chill stage may include pre-chilling just pump 7 or pre-chilling both pump 7 and dispenser 3. Pre-chilling pump 7 may occur, for example, by flowing fluid into the pump chamber in which pump 7 is located. Processor 11 may send a signal to flow fluid into the pump chamber to cool pump 7 to prepare pump 7 for pumping LNG to dispenser 3. Processor 11 may also send a signal to pump 7 to begin supplying LNG to dispenser 3 to pre-chill dispenser 3. Accordingly, some embodiments of LNG dispensing system 1 are configured to anticipate the need to dispense LNG and prepare pump 7, or pump 7 and dispenser 3, for dispensing LNG before a demand for (or request to dispense LNG) is received, e.g., from a vehicle operator. This decreases lag time or delay between the input of an LNG demand and when dispenser 3 begins dispensing LNG, or allows dispenser 3 to begin dispensing as soon as a demand for LNG is received, reducing or altogether eliminating wait time.

In the exemplary embodiment of FIG. 6, LNG dispensing system 1 may include a vehicle detection subsystem 40. Vehicle detection subsystem 40 may include one or more sensors 32 configured to detect the approach of a vehicle 5. Once the sensor(s) detect a vehicle 5, the sensor(s) 32 relay this information to processor 11. Processor 11 selectively uses the information from the sensor(s) 32 to initiate the pre chill stage (described above) and prepares pump 7 and/or LNG dispenser 3 for dispensing LNG.

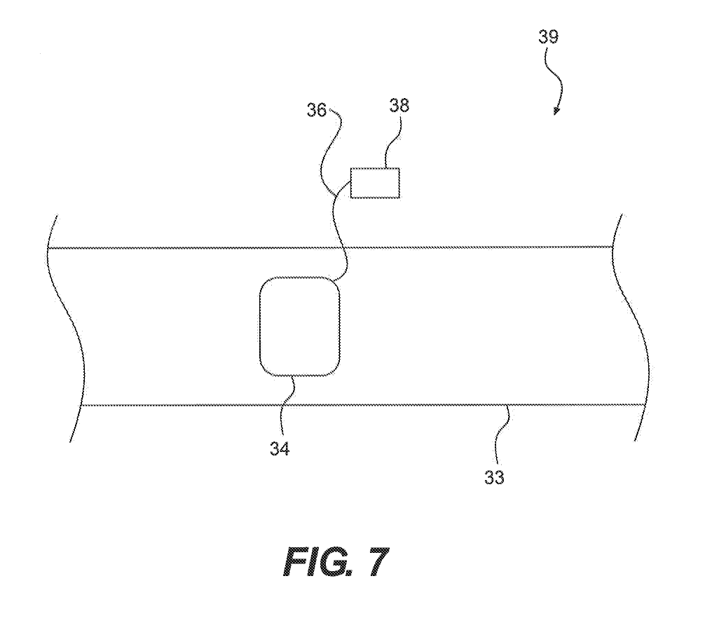

As is depicted in the embodiment of FIG. 7, an exemplary vehicle detection subsystem includes a loop detector system 39. The loop detector system 39 comprises one or more induction loops (coils) 34 installed under, in, or within an entry area of an LNG dispensing station or a region in the vicinity of LNG dispenser 3. The particular location of loops 34 is determined based on the station configuration, location of dispensers within the station, proximity of dispensers to the station perimeter, and/or an amount of time required for the pre-chill stage. In the embodiment of FIG. 7, induction loop 34 is installed within the surface of an area of pavement 33. A loop extension cable 36 may connect loop 34 to a detector 38, though in some embodiments, induction loop 34 may be wirelessly coupled to detector 38. Detector 38 may be included as part of processor 11 or may be separate from processor 11. Induction loop 34 may be configured to resonate at a substantially constant frequency, and this frequency may be monitored by detector 38.

In operation, when a vehicle passes or comes to rest over induction loop 34, or passes or comes to rest within a pre-determined distance of induction loop 34, the frequency or inductance may change, e.g., the frequency may increase or the inductance may decrease. Detector 38 may detect this change in frequency and/or inductance, and detector 38 may output a signal to processor 11 indicating the presence of a vehicle. Exemplary loop detectors may include saw cut or preformed loops. The signals generated by loop detection system 39 may be in the form of DC, AC, or both DC and AC output. Loop detection system 39 may further include any suitable low-voltage loop detection units (e.g. in the range of 1.5-38 VDC) or high-voltage detection units (e.g., 100-300 VAC), or any combination thereof.

In response to a signal from detector 38, processor 11 initiates the pre chill process for pump 7 and/or LNG dispenser 3. Operation timing is set such that by the time the vehicle operator reaches dispenser 3, exits the vehicle, connects the vehicle to LNG dispenser 3, and/or inputs a demand for LNG, pump 7 and/or dispenser 3 is cooled down and ready to dispense LNG. Or, if pump 7 and/or LNG dispenser 3 has not yet reached a cool enough temperature for dispensing LNG, the operator may experience a shorter wait time than would otherwise occur due to the preemptive initiation of the pre-chill process. Thus, a vehicle may approach an LNG dispenser 3, triggering the pre-chill process. The operator may then exit the vehicle, connect the vehicle tank to the dispenser, and input a demand for LNG, at which time the dispenser may be ready (or almost ready) to begin dispensing LNG fuel. Once dispensing is completed, the pre-chill process may cease, and the dispenser may be allowed to return to a non-chilled temperature. Alternatively, if another vehicle is detected after dispensing is completed for the current vehicle, e.g., if another vehicle approaches or is waiting in line, the pre-chill process may initiate again, if needed.

In some exemplary embodiments, when loop detector system 39 detects the presence of a vehicle but no LNG demand is received within a set time period, processor 11 stops the pre-chill process. For example, processor 11 may be programmed to initiate the pre-chill process in response to a detected vehicle, but only for a pre-determined amount of time. Once that time limit is reached, processor 11 may stop the pre-chill process if no request for LNG is received by the dispensing station. This may conserve energy and/or control the amount of heat that is generated as a result of putting the dispenser into pre-chill mode.

In some embodiments, if more than one LNG dispenser is located at a service station, each LNG dispenser may have its own loop detection system 39. Accordingly, an approaching vehicle may only trigger the pre-chill process for the specific LNG dispenser that the vehicle is approaching, as opposed to triggering the pre-chill process for multiple dispensers. In some embodiments, to determine which LNG dispenser a vehicle operator intends to use, loop detection system 39 for a given dispenser may only be activated after a vehicle slows to a pre-determined speed or stops over a certain area for a pre-determined amount of time. In some embodiments, the pre-chili process may only be triggered for the amount of time that the vehicle is located above induction loop 34. This may allow a vehicle driving past one dispenser in order to access another dispenser to activate only the pre-chill process of the intended dispenser rather than both the dispenser that was driven past and the intended dispenser. Further, if more than one loop detection system 39 is included (e.g., one for each dispenser), then each loop detection system 39 may be individually controllable. For example, if a particular LNG dispenser is out of service, the vehicle detector for that dispenser may be turned off so that an approaching vehicle could not initiate the pre-chill process. Additionally, if multiple induction loops 34 and/or loop detectors 38 are used in the same vicinity, they may be configured so as to minimize cross-talk. For example, the frequencies at which induction loops 34 operate may be slightly offset from one another. Further, if multiple induction loops 34 are used, each induction loop 34 may be operably coupled to its own detector 38, or multiple induction loops 34 may be connected to a common detector 38. Again, detector(s) 38 may be separate from processor 11 and may relay a signal to processor 11 or may be included as part of processor 11.

While a loop detection system is described in the example embodiment above, any vehicle detection system 40 may be used instead of, or in addition to, an induction loop. For example, one or more sensors for detecting motion, pressure, temperature, audio, video, light, or any other suitable parameter may be included. Suitable sensors may include, e.g., sonar sensors, ultrasound sensors, pressure gauges, thermal sensors, electromagnetic or magnetic sensors, radar sensors, microwave sensors, light- or image-based sensors (e.g., infrared sensors or reflective sensors), inductive sensors, capacitive sensors, frequency sensors, photoelectric sensors, piezoelectric cables, motion sensors (e.g., for detecting vibrations or larger movement), or any suitable combination thereof.

In some embodiments, radio-frequency identification (RFID) sensors and detectors may be used. An RFID vehicle detection system may include one or more of an RFID device (transponder or tag) mounted on a vehicle, an antenna to transmit RF signals, a transceiver (module) to generate RF signals, and/or a reader to receive RE transmissions from the RFID device. The reader may also relay information about detected vehicles to processor 11. The RFID device may be either active (i.e., actively transmits to a reader) or passive (i.e., only reflects or backscatters transmissions from a reader), and may be placed on a vehicle to be detected. For example, customers of a dispensing station or chain of dispensing stations may acquire an RFID device to affix to their vehicles, which may trigger the detection system upon entry. The identification component of RFID devices may also add an efficient payment method. For example, if a user account is linked to a specific RFID device, detection of the RFID device may not only initiate the pre-chill process, but the dispenser display may also be able to provide the option of paying via an already established credit or debit account instead of requiring provision of a payment form on-site to dispense LNG.

In exemplary pressure-based vehicle detection systems, one or more pneumatic tubes (e.g., pressure hose) or weigh-in-motion sensors (e.g., piezoelectric, bending plate, load cell, and/or capacitance mat) may be placed across a detection area, for example, either under, on, or within a region of pavement. A pneumatic tube may be filled with air or a suitable fluid. One end of the tube may be connected to a detection unit, and one end of the tube may be connected to an air switch. When a vehicle crosses the pressure tube, a pulse may be generated. In response to the pulse, the detector may alert processor 11 to the presence of a vehicle.

In an exemplary radar-based vehicle detection system, one or more sensors may be mounted above, below, or to the side of a detection area, for example, on a wall or a side of the dispensing station, on an overhang or ceiling of the dispensing station, or on a sign or pole near the station. The radar sensor may be configured to detect stationary or moving vehicles while ignoring other objects, such as humans or animals. Additionally, radar-based sensors may be configured so that they are not substantially affected by other environmental factors, such as wind, light, temperature, or precipitation.

In an infrared-based system, an infrared sensor may be mounted above, below, or to the side of a detection area, for example, on a wall or a side of the dispensing station, on an overhang or ceiling of the dispensing station, or on a sign or pole near the station. The sensor may detect heat emitted from vehicles that pass through the detection area. An optical receiver may detect waves of near infrared rays, and/or may both emit and receive waves of infrared rays. Exemplary infrared detection systems may include far infrared detectors or traditional infrared sensors. Infrared detection systems may be configured to detect stationary or moving vehicles while ignoring other objects, such as humans or animals. Additionally, infrared-based sensors may be configured so that they are not substantially affected by other environmental factors, such as wind, light, temperature, or precipitation.

In an exemplary ultrasonic vehicle detector, one or more ultrasound detectors may be mounted above the detection area, for example, on a wall or a side of the dispensing station, on an overhang or ceiling of the dispensing station, or on a sign or pole near the station. The detectors may transmit waves toward the roadway and may be configured to detect vehicles based on differences in the arrival times of waves reflected from vehicles and the road. The ultrasound sensors may be configured to detect stationary or moving vehicles while ignoring other objects, such as humans or animals. Additionally, ultrasound-based sensors may be configured so that they are not substantially affected by other environmental factors, such as wind, light, temperature, or precipitation.

Exemplary sensor/detector systems may be wireless or hard-wired, may include standard or MEMs sensor technology, and may include separate detector components or components that are incorporated into processor 11. Additionally, sensors may operate using a narrow detection field (or beam) or may operate using a larger detection field, depending on the size of the intended detection area, e.g., or the level of desired specificity. For example, in embodiments in which a single dispenser may be accessed from a number of angles, a broader detection field may be desired. In embodiments in which multiple dispensers are arranged near each other, or in which only a narrower access path is available to vehicles, a narrower detection field may be used. In some embodiments, sensors may be adjustable between more narrow and more broad detection areas to accommodate different configurations and/or uses.

Alternatively, instead of an automatic vehicle detection system, some embodiments may include a manual vehicle detection system. For example, a station employee may be able to activate the pre-chill process when the employee sees or otherwise detects a customer approaching, or once a customer provides payment to the employee. In some embodiments, such manual systems may be included in addition to automatic detection systems, e.g., as a backup in case the automatic detection system is down, e.g., for service or repair. Additionally, automatic detection systems may include a manual override option or may include emergency shutoffs, for example.

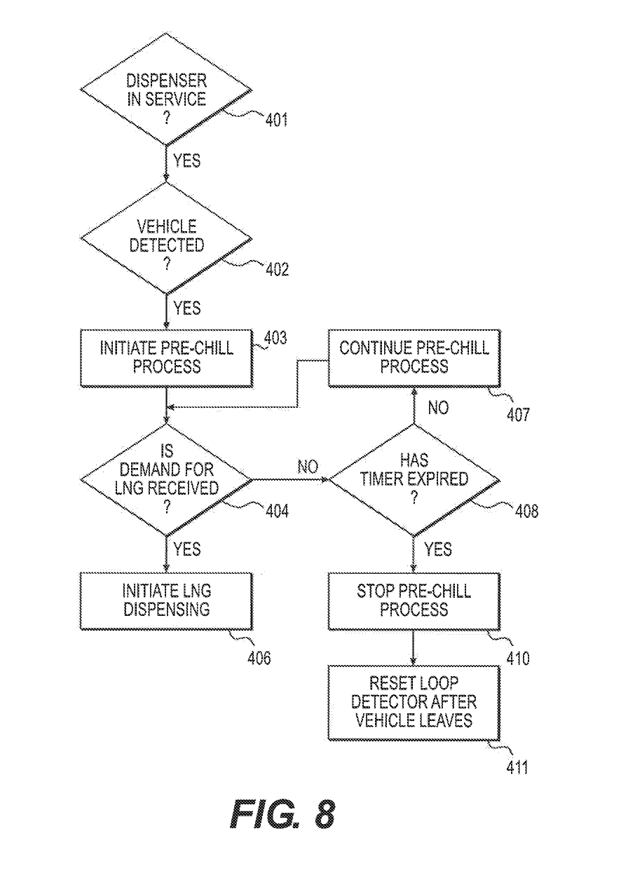

As is depicted in FIG. 8, an LNG dispensing system 1 with a vehicle detection system 40 may initiate the pre-chill process as follows. If a dispenser is in service (step 401), and a vehicle is detected (step 402), the pre-chill process may be initiated (step 403). If a vehicle operator inputs a demand for LNG and the LNG dispenser 3 receives the demand (step 404), then the LNG dispenser may initiate dispensing (step 406), once a suitable temperature has been reached. If no demand for LNG is received, then the pre-chill process may continue (step 407). However, if a pre-determined amount of time has expired (step 408) since the initiation of the pre-chill process without receipt of a demand for LNG, then the pre-chill process may be stopped (step 410). If this occurs, the loop detector may be reset once the vehicle leaves the detection area (step 411). Alternatively, the chilling process may again be initiated if the vehicle operator eventually does input a demand for LNG after expiration of the allotted amount time. In this situation, LNG dispenser 3 may work similarly to embodiments that do not include a vehicle detection system 40.

Accordingly, a method of dispensing LNG may include detecting an approaching vehicle, initiating a pre-chill process, receiving a demand for LNG, and delivering LNG. Initiating the pre-chill process before receiving a demand may allow the dispenser to reach a pre-determined dispensing temperature prior to receiving the demand for LNG, or shortly thereafter. If no demand is received following initiation of the pre-chill process, then the method may include stopping the pre-chill process after a pre-determined amount of time has lapsed. The method may further include resetting the vehicle detection system once the detected vehicle leaves.

The many features and advantages of the present disclosure are apparent from the detailed specification, and thus, it is intended by the appended claims to cover all such features and advantages of the present disclosure that fall within the true spirit and scope of the present disclosure. Further, since numerous modifications and variations will readily occur to those skilled in the art, it is not desired to limit the present disclosure to the exact construction and operation illustrated and described, and accordingly, all suitable modifications and equivalents may be resorted to, falling within the scope of the present disclosure.

What is claimed is:

1. A dispensing system for dispensing a cryogenic fluid, the system comprising:
a cryogenic fluid dispenser;
a pump;
a conduit connecting the pump to the dispenser;
a processor; and
a vehicle detection subsystem configured to detect a vehicle,
wherein when the vehicle detection subsystem provides to the processor a signal reflecting detection of a vehicle, the processor initiates a pre-chill operation, wherein the pre-chill operation prepares at least one of the pump or the dispenser to dispense the cryogenic fluid.

2. The dispensing system of claim 1, wherein the cryogenic fluid dispenser includes:
a measurement chamber configured to receive the cryogenic fluid, the measurement chamber including at least one probe for measuring a property of the cryogenic fluid,
a first conduit including an inlet in fluid communication with the measurement chamber,
a flow meter coupled to the first conduit, and
a second conduit configured to return the cryogenic fluid to a source, wherein the inlet, the second conduit, and the flow meter are vertically stacked relative to each other along the first conduit.

3. The dispensing system of claim 1, wherein the vehicle detection subsystem includes at least one of an induction loop, an infrared sensor, a pressure sensor, a radio-frequency identification sensor, an ultrasonic sensor, or a radar sensor.

4. The dispensing system of claim 1, wherein the vehicle detection subsystem includes a sensor configured to detect a vehicle in the vicinity of the cryogenic fluid dispenser.

5. The dispensing system of claim 1, comprising a plurality of dispensers and a plurality of sensors, wherein each of the plurality of sensors is configured to detect a vehicle in the vicinity of one of the plurality of dispensers.

6. The dispensing system of claim 2, wherein the at least one probe includes a temperature probe.

7. The dispensing system of claim 2, wherein the second conduit is configured to directly deliver the cryogenic fluid to the flow meter.

8. The dispensing system of claim 1, wherein the cryogenic fluid is liquefied natural gas.

9. A dispensing system for dispensing a liquid, comprising:
a pump;
a liquid dispenser having:
a measurement chamber configured to receive the liquid, the measurement chamber including at least one probe for measuring a property of the liquid,
a first conduit configured to deliver the liquid out of the dispenser,
a flow meter coupled to the first conduit, and
a second conduit configured to return the liquid to a source, wherein the second conduit is positioned upstream of the flow meter;
a vehicle detection subsystem; and
a processor operably coupled to the vehicle detection subsystem, the pump, and the liquid dispenser.

10. The dispensing system of claim 9, wherein the vehicle detection subsystem includes at least one of an induction loop, an infrared sensor, a pressure sensor, a radio-frequency identification sensor, an ultrasonic sensor, or a radar sensor.

11. The dispensing system of claim 9, wherein the vehicle detection subsystem includes a sensor configured to detect a vehicle in the vicinity of the liquid dispenser.

12. The dispensing system of claim 9, comprising a plurality of dispensers and a plurality of sensors, wherein each of the plurality of sensors is configured to detect a vehicle in the vicinity of one of the plurality of dispensers.

13. The dispensing system of claim 9, wherein the at least one probe includes a temperature probe and a capacitance probe.

14. A method for dispensing a liquid from a dispenser, comprising:
anticipating a demand for the liquid;
initiating a pre-chill process to cool at least one of the dispenser or a pump associated with the dispenser to at least a predetermined temperature;
receiving a demand for the liquid; and
dispensing the liquid once at least one of the dispenser or the pump is cooled to the predetermined temperature.

15. The method of claim 14, wherein at least one of the dispenser or the pump is cooled to the predetermined temperature before the demand is received.

16. The method of claim 14, wherein anticipating the demand for the liquid includes detecting a vehicle using a vehicle detection subsystem.

17. The method of claim 16, further comprising resetting the vehicle detection subsystem once the vehicle is no longer present.

18. The method of claim 14, wherein the liquid is natural gas.

19. The method of claim 14, wherein the pre-chill process includes pumping the liquid from a liquid source, through the pump, through the dispenser, and returning the liquid to the liquid source.

20. The method of claim 14, wherein the pump is located within a chamber and the pre-chill process includes flowing fluid into the chamber.

21. A method for dispensing a liquid from a dispenser, comprising:
detecting the presence of a vehicle; and
initiating a pre-chill process to cool at least one of the dispenser or a pump associated with the dispenser to at least a predetermined temperature upon detection of the vehicle.

22. The method of claim 21, wherein the liquid is natural gas.

23. The method of claim 21, wherein the pre-chill process is initiated for a predetermined amount of time.

24. The method of claim 23, further comprising:
stopping the pre-chill process if no demand for the liquid is received within the predetermined amount of time.

25. The method of claim 23, wherein a vehicle detection subsystem is used to detect the presence of the vehicle, and wherein the method further comprises resetting the vehicle detection subsystem once the vehicle is no longer present.

26. The method of claim 21, further comprising:
receiving a demand for the liquid; and
dispensing the liquid.

27. The method of claim 26, wherein the predetermined temperature is reached before the demand for the liquid is received.

28. The method of claim 21, wherein the pre-chill process includes pumping the liquid from a liquid source, through the pump, through the dispenser, and returning the liquid to the liquid source.
